(19) United States
(12) Patent Application Publication
(10) Pub. No.: US 2005/0120968 A1
(43) Pub. Date: Jun. 9, 2005

(54) Pet furniture

(76) Inventor: Natalie Dorsey, Hollywood, FL (US)

Correspondence Address: LERNER AND GREENBERG, PA, P O BOX 2480, HOLLYWOOD, FL, 33022-2480, US

(21) Appl. No.: 10/722,023

(22) Filed: Nov. 25, 2003

(51) Int. Cl. A01K 29/00

(52) U.S. Cl. 119/165

(57) ABSTRACT

A pet furniture item includes a sanitary compartment for receiving a litter box. The sanitary compartment has a litter container for storing clean unused litter to be dispensed into the litter box. A feeding compartment that is separate from the sanitary compartment is included. The furniture also has a storage compartment that is separate from the sanitary compartment and the feeding compartment.

### BACKGROUND OF THE INVENTION

1. Field of the Invention

The invention relates to an apparatus that can be used to accommodate the needs of a pet such as a cat and, more specifically, to a piece of furniture where a cat can go to eat, drink, sleep, and to use a litter box.

2. Description of the Related Art

U.S. Pat. No. 3,872,832 (Quinn) discloses cat furniture, which includes two hinged doors, which allows a litter box to be removed from the furniture. A removable end panel is provided so that the side of the furniture providing access to the litter area can be hidden in a corner.

U.S. Pat. No. 6,182,612 B1 (Ross, Sr.) discloses a cat cabinet having sides, which include punchouts allowing a cat access to the cat cabinet on separate levels. A remaining side of the cabinet includes doors, which provide access to place litter boxes and supplies. The cat cabinet also includes a removable top.

U.S. Pat. No. 6,286,458 B1 (Rawson) discloses an enclosure for a domestic animal in a piece of furniture. The enclosure includes an area for a litter box and an area for pet supplies. A hinged door allows the litter box and other supplies to be placed in the enclosure. An opening with a flap allows an animal to move in and out of the litter box area.

U.S. Pat. No. 6,394,035 B1 (Hill) discloses a pet enclosure for use with a door. The enclosure has a tunnel unit that is attached to a door, which allows a pet to enter the enclosure from outside of the door. The enclosure includes a litter area and an eating/sleeping area, which have an opening allowing the pet to travel between the eating/sleeping area and the litter area.

The above-mentioned prior art references have the disadvantages that none of the reference discloses a device having a litter container for storing unused litter. None of the references discloses that a litter container has a configuration, which can be sealed. Furthermore, they do not provide one unit, which includes a sanitary compartment for a litter box, litter container for unused litter, and cleaning tools, a separate storage compartment for food and supplies, along with a separate feeding compartment that is separated from the litter box for sanitary purposes.

### SUMMARY OF THE INVENTION

It is accordingly an object of the invention to provide an apparatus for a pet which overcomes the above-mentioned disadvantages of the heretofore-known devices and methods of this general type and which provides for an aesthetically pleasing furniture piece that has the appearance of a normal piece of furniture, for example a chest of drawers. The furniture should provide a pet owner with an area to store large bags of litter, easy dispensing of the litter into the litter pan, separate food storage compartment to hold a large bag of food and supplies, built-in garbage hooks to provide easy removal of waste from a cat box, and a holder to hold bags and a litter scoop. The furniture should also provide pets a place to sleep, use the litter box, and a private area to eat and drink.

With the foregoing and other objects in view there is provided, in accordance with the invention, a pet furniture item including a sanitary compartment for receiving a litter box therein and a feeding compartment that is separate from the sanitary compartment. A storage compartment that is separate from the sanitary compartment and the feeding compartment is provided. A litter container for storing clean unused litter to be dispensed into the litter box is included.

In accordance with another feature of the invention, the litter container is a litter drawer.

In accordance with a further feature of the invention, the litter drawer has a slanted bottom region and a litter dispensing hose is attached to the litter drawer at the slanted bottom region.

In accordance with an added feature of the invention, the litter dispensing hose is sealed by a cap.

In accordance with an additional feature of the invention, the litter dispensing hose has a holding device for holding the litter dispensing hose.

In accordance with yet another feature of the invention, there is provided a pull-out tray disposed in the sanitary compartment which holds the litter box.

In accordance with yet a further feature of the invention, there is provided a pull-out tray disposed in the feeding compartment for holding a food dish and a water dish.

In accordance with yet an added feature of the invention, the feeding compartment and the sanitary compartment are separated by a wall.

In accordance with yet an additional feature of the invention, the feeding compartment and the storage compartment are separated by a shelf.

In accordance with still another feature of the invention, there is provided a countertop which includes an openable portion and a fixed portion.

In accordance with still a further feature of the invention, the storage compartment is accessible through the openable portion of the countertop.

In accordance with still an added feature of the invention, there is provided a bed disposed on top of the fixed portion of the counter top.

In accordance with still an additional feature of the invention, there is provided at least one pole being a scratching post and supporting the bed.

In accordance with another feature of the invention, the at least on pole is two poles each having brackets for supporting the bed.

In accordance with a further feature of the invention, there is provided a hammock suspended from the brackets.

In accordance with an added feature of the invention, there is provided a supply holder disposed in the sanitary compartment.

In accordance with an additional feature of the invention, there are provided two hooks disposed in the sanitary compartment for holding a litter disposal bag.

In accordance with yet another feature of the invention, there is provided at least one door for closing the sanitary compartment, the at least one door having at least one pet entrance opening formed therein.

In accordance with a concomitant feature of the invention, the at least one door is two doors each having a complementary one of the openings formed therein.

In accordance with a further concomitant feature of the invention, there is provided a roll top door for closing the feeding compartment.

With the objects of the invention in view, there is also provided, a pet furniture item having a sanitary compartment for receiving a litter box therein and a feeding compartment that is separate from the sanitary compartment. A litter container has a slanted bottom region, the litter container stores clean unused litter to be dispensed into the litter box and a litter dispensing hose is attached to the litter container at the slanted bottom region.

With the objects of the invention in view, there is furthermore provided, a pet furniture item having a sanitary compartment for receiving a litter box therein and a litter container having a slanted bottom region. The litter container stores clean unused litter to be dispensed into the litter box and a litter dispensing hose is attached to the litter container at the slanted bottom region.

Other features which are considered as characteristic for the invention are set forth in the appended claims.

Although the invention is illustrated and described herein as embodied in the pet furniture, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 is a diagrammatical front-elevational view of the interior of the novel pet furniture according to the invention;

FIG. 2 is a left-side elevational view of the interior of the furniture according to FIG. 1;

FIG. 3 is a right-side elevational view of the interior of the furniture according to FIG. 1;

FIG. 4 is a front-side elevational view of the exterior of the furniture according to FIG. 1;

FIG. 5 is a left-side elevational view of the exterior of the furniture according to FIG. 1;

FIG. 6 is a right-side elevational view of the exterior of the furniture according to FIG. 1;

FIG. 7 is a top-plan view of the exterior of the furniture according to FIG. 1;

FIG. 8 is a top-plan view of the hammock of the furniture according to FIG. 1;

FIG. 9 is an enlarged, elevational view of a litter feeding assembly;

FIG. 10 is an enlarged, elevational view of a bag hook;

FIG. 11 is an enlarged, elevational view of a litter drawer;

FIG. 12 is an enlarged, elevational view of a hose holding device; and

FIG. 13 is an enlarged, side-elevational view of the hose holding device.

### DESCRIPTION OF THE PREFERRED EMBODIMENTS

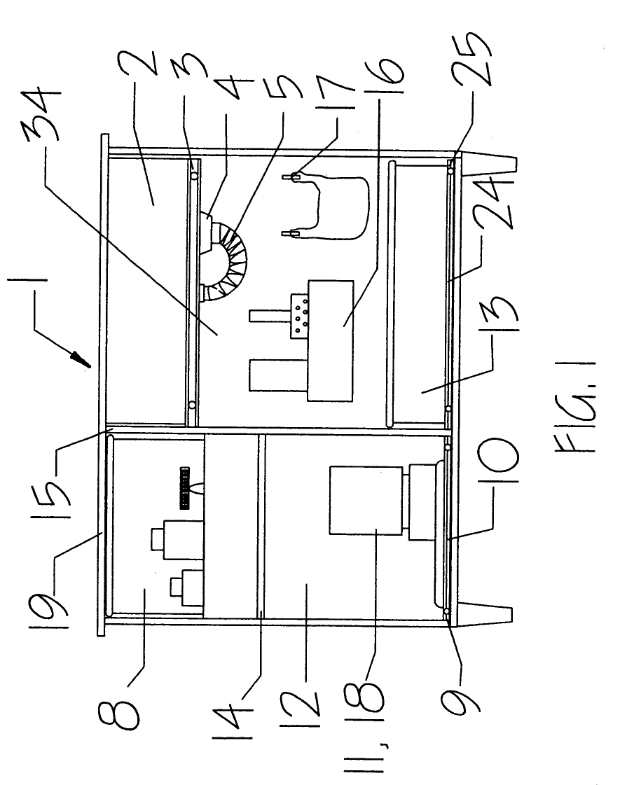

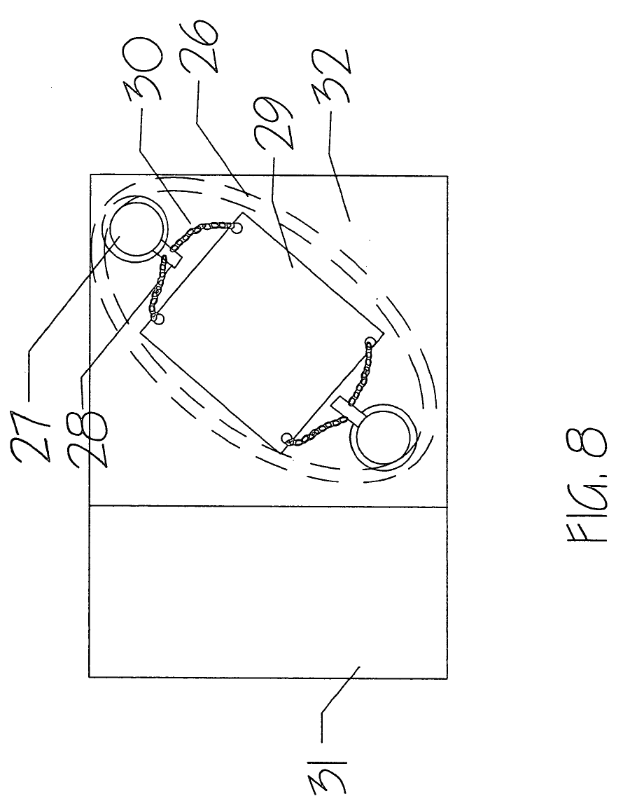

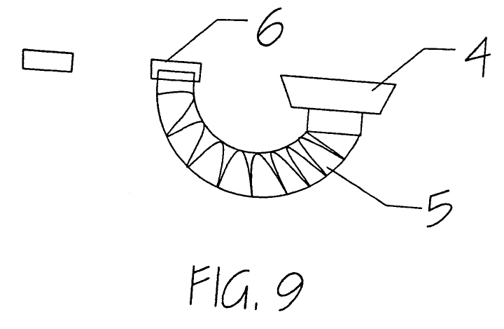

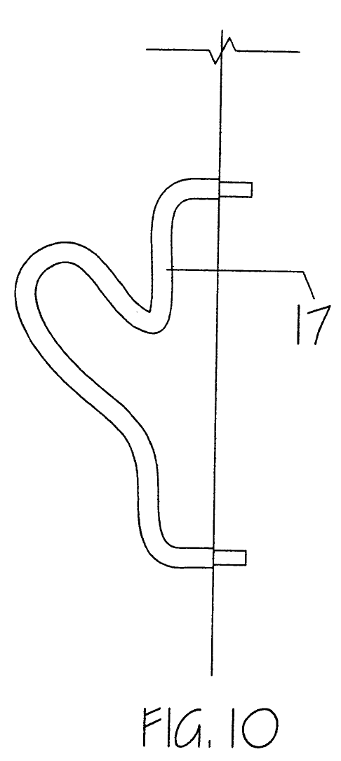

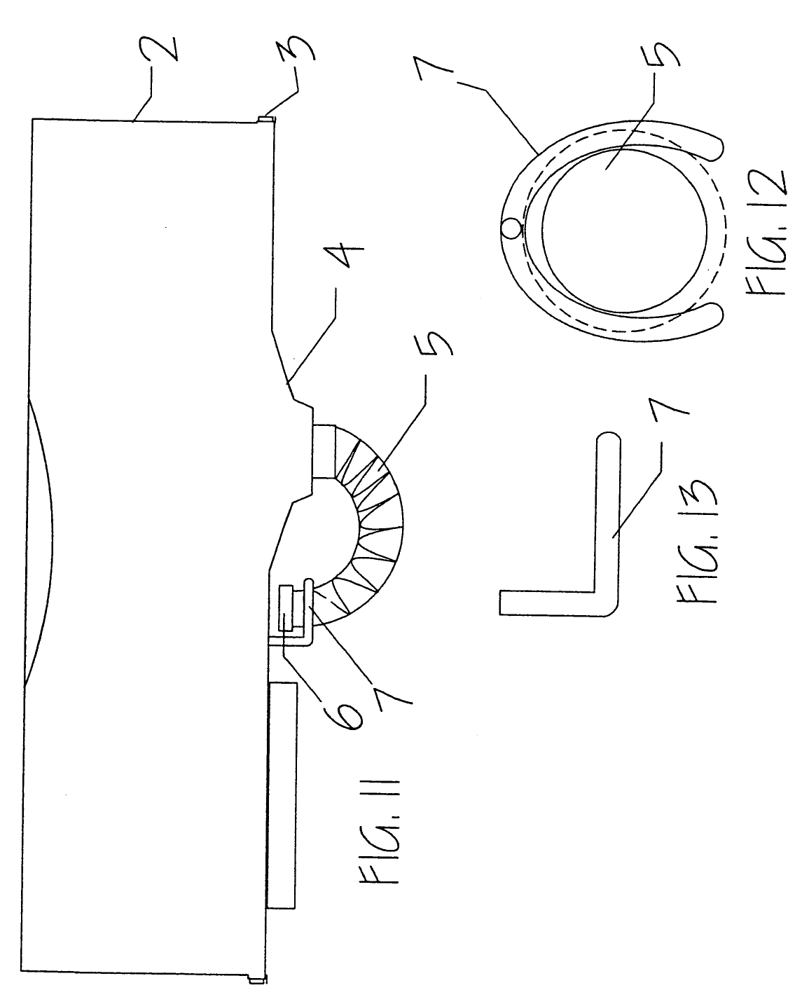

Referring now to the figures of the drawing in detail and first, particularly, to FIG. 1 thereof, there is seen a piece of cat furniture 1 according to the invention, specifically cat furniture in the illustrated embodiment, although the invention is not limited to furniture for any specific animal. The cat furniture 1 includes a litter drawer 2 in a sanitary compartment 34. The litter drawer 2 has a slanted region in part of a bottom 4 thereof for supplying clean unused litter to a litter box 13 located in the sanitary compartment 34. The unused litter is supplied from the litter drawer 2 to the litter box 13 by a hose 5 connected at the slanted region of the bottom 4 of the litter drawer 2 (which is better seen in FIG. 9). The hose 5 has a cap 6, which seals the hose and a holder 7 (seen in FIGS. 12 and 13) holds the hose 5 when the hose 5 is not in use (as is also seen in FIG. 11). Of course, another dispenser, such as a chute instead of a hose, could be used. The litter drawer 2 is provided with guides 3, which allow access for filling the litter drawer 2 with unused litter. The sanitary compartment 34 contains a holder 16 for litter cleaning supplies, for example a litter scoop and bags (plastic shopping store bags with handles) for the used litter. Also provided on a wall of the sanitary compartment 34 are two hooks 17 for holding the bags during the transfer of the used litter from the litter box 13 to the bag. The sanitary compartment 34 includes a pull out tray 25 for the litter box 13, which is provided on guides 24.

The cat furniture 1 includes a divider wall 15, which separates the sanitary compartment 34 containing the cat litter from a feeding compartment 12 for feeding and watering a cat and a storage compartment 8 for storing food and other supplies. A shelf 14 divides the compartments 8 and 12. The feeding compartment 12 includes a pull out tray 9, which is provided with guides 10. The pull out tray 9 allows easy access for filling a food dish 11 and a water dish 18.

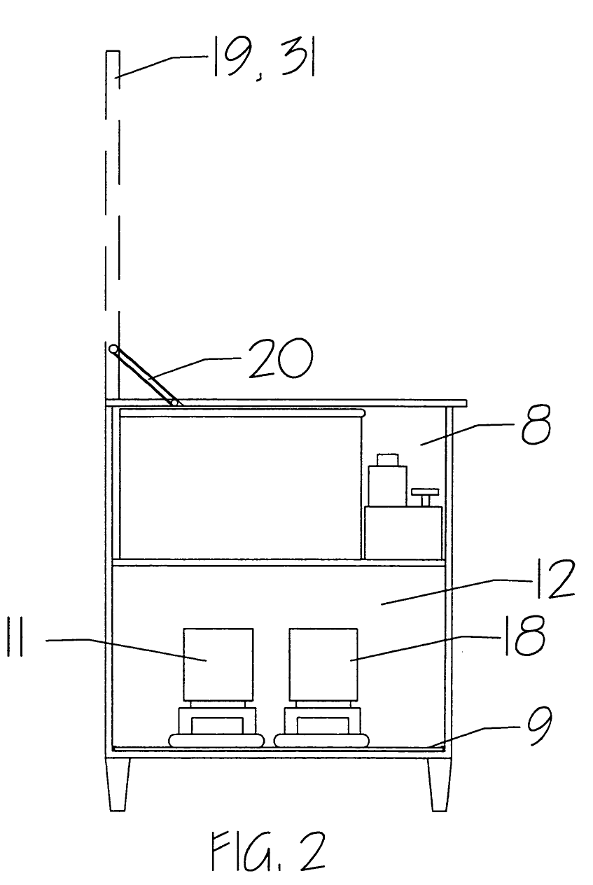

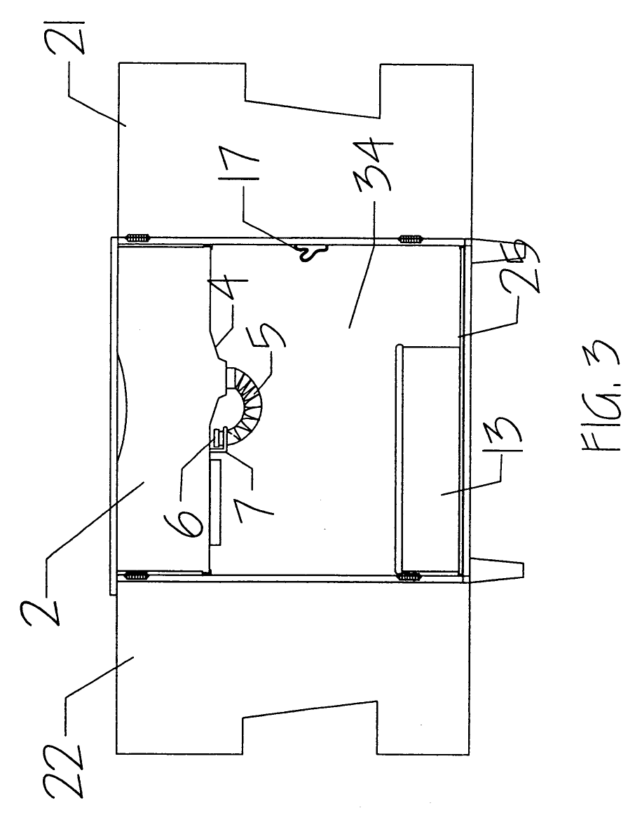

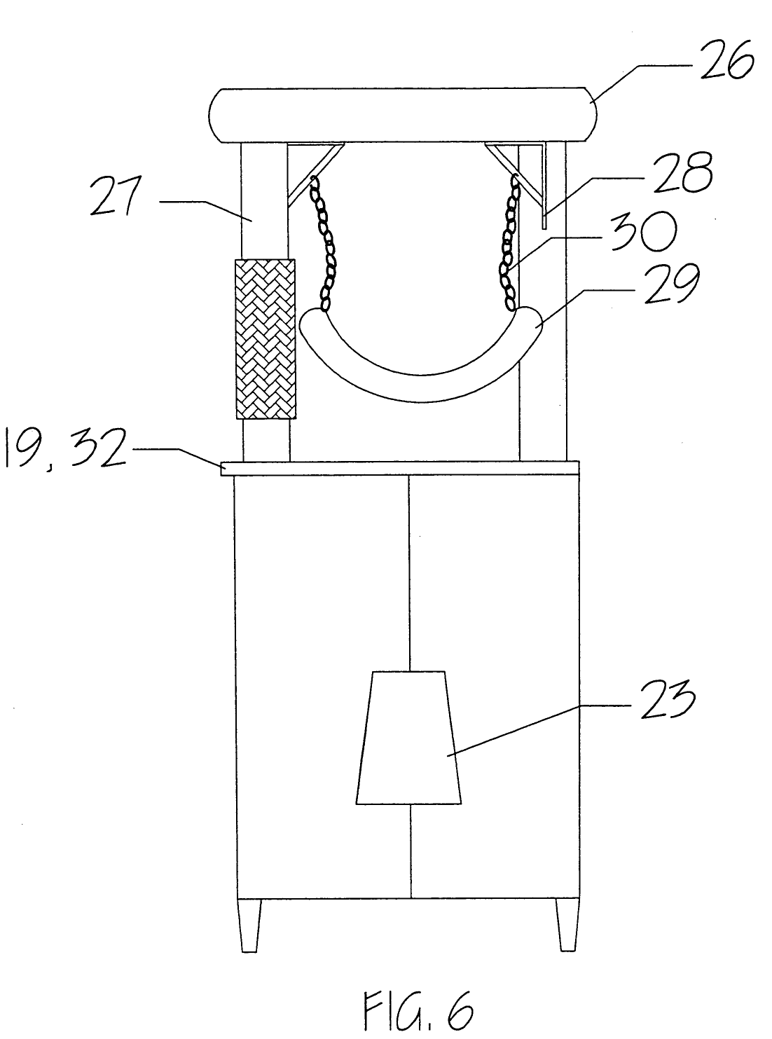

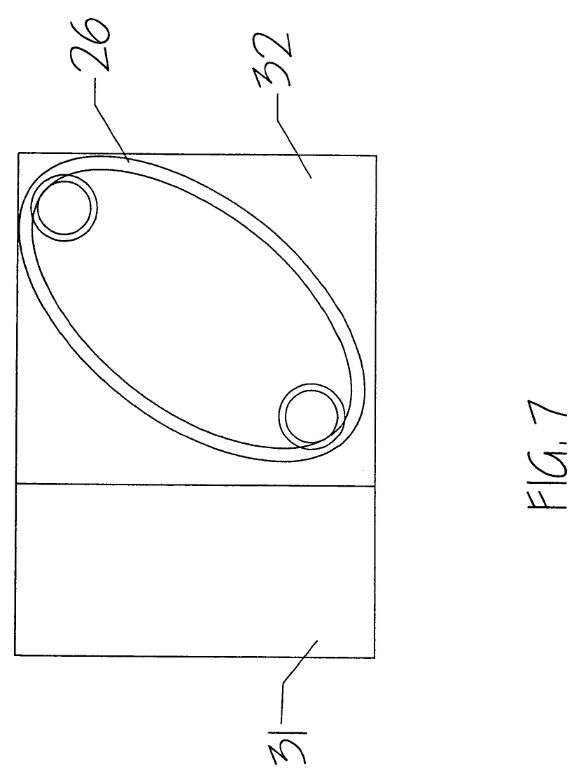

As can be more readily seen in FIGS. 6 and 7, the cat furniture has a counter top 19, which is split into two parts, an openable part 31 and a fixed part 32. The opening part 31 provides access to the storage compartment 8. The openable part 31 of the counter top 19 includes hinges 20 for opening (as seen in FIG. 2).

FIG. 3 is a side-elevational view showing the sanitary compartment 34 in more detail. The sanitary compartment 34 contains the litter drawer 2 and the litter box 13. The sanitary compartment 34 has doors 21 and 22, which provide access to the litter drawer 2 and the litter box 13. When the doors 21 and 22 are open, the litter drawer 2 and the pull out tray 25 can be pulled out for any required attention. When the doors 21 and 22 are closed a cat has access to the litter box 13 through an opening 23 formed in the doors 21 and 22, as is seen in FIG. 6.

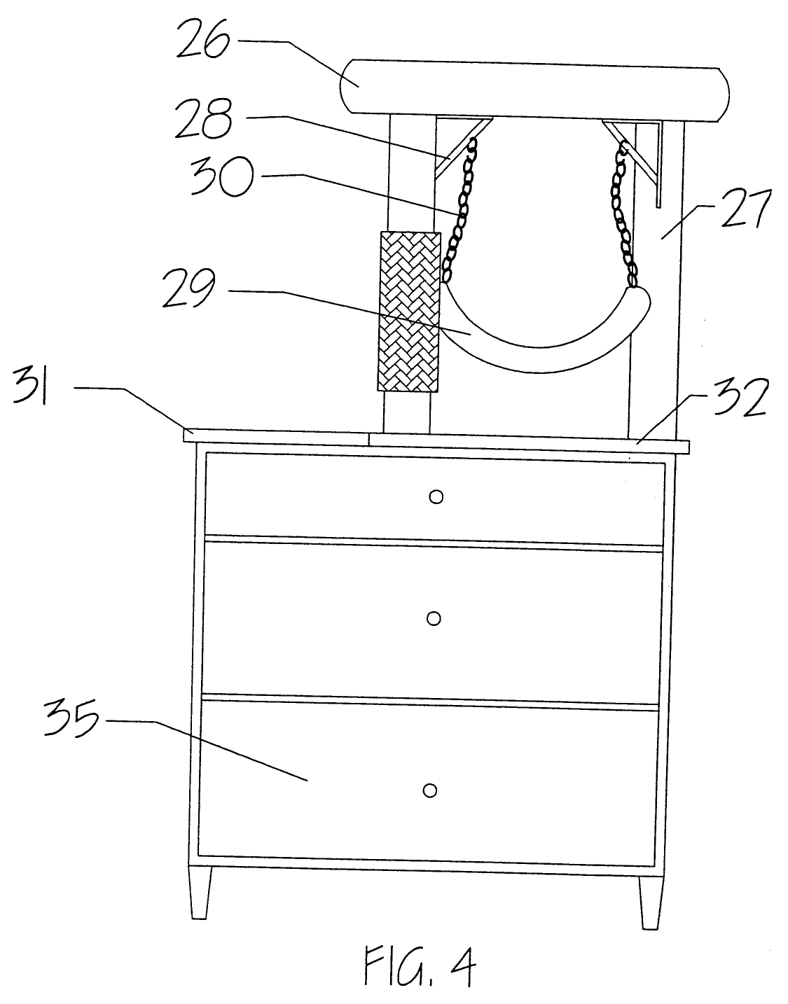

FIG. 4 shows the front of the cat furniture 1 which has a wall 35. The wall 35 can be decorated to resemble drawers and/or doors to simulate a piece of regular furniture, such as a chest of drawers. A bed 26 for a cat is provided on poles 27 and brackets 28 are provided to support the bed 26. The poles 27 are mounted on the fixed side 32 of the counter top 19. The poles 27 can also be used as a scratching post. The brackets 28 are also used to suspend a hammock bed 29, which is attached by chains 30.

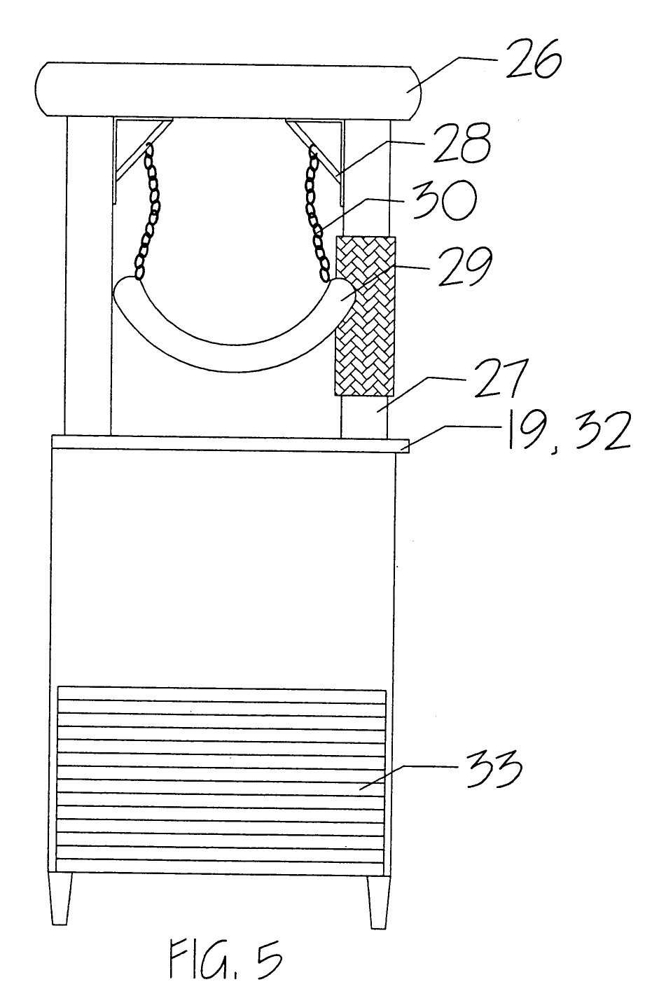

FIG. 5 is a side-elevational view, which shows another view of the bedding structures. A roll top door 33 is provided to close off the feeding area 12 when not in use.

In another embodiment the pet furniture only includes the sanitary compartment 34 containing the litter drawer 2 and the litter box 13. The sanitary compartment 34 has doors 21 and 22, which provide access to the litter drawer 2 and the litter box 13. When the doors 21 and 22 are open, the litter drawer 2 and the pull out tray 25 can be pulled out for any required attention. When the doors 21 and 22 are closed a cat has access to the litter box 13 through an opening 23 formed in the doors 21 and 22.

1. A pet furniture item, comprising:
a sanitary compartment for receiving a litter box therein;
a feeding compartment being separate from said sanitary compartment;
a storage compartment being separate from said sanitary compartment and said feeding compartment; and
a litter container for storing clean unused litter to be dispensed into the litter box.

2. The item of furniture according to claim 1, wherein said litter container is a litter drawer.

3. The item of furniture according to claim 2 wherein said litter drawer has a slanted bottom region and a litter dispensing hose is attached to said litter drawer at said slanted bottom region.

4. The item of furniture according to claim 3, further comprising a cap for sealing said litter dispensing hose.

5. The item of furniture according to claim 4, further comprising a holding device for said litter dispensing hose.

6. The item of furniture according to claim 1, further comprising a pull-out tray disposed in said sanitary compartment for holding the litter box.

7. The item of furniture according to claim 1, further comprising a pull-out tray disposed in said feeding compartment for holding a food dish and a water dish.

8. The item of furniture according to claim 1, wherein said feeding compartment and said sanitary compartment are separated by a wall.

9. The item of furniture according to claim 1, wherein said feeding compartment and said storage compartment are separated by a shelf.

10. The item of furniture according to claim 1, further comprising a countertop including an openable portion and a fixed portion.

11. The item of furniture according to claim 10, wherein said storage compartment is accessible through said openable portion of said countertop.

12. The item of furniture according to claim 10, further comprising a bed disposed on top of said fixed portion of said counter top.

13. The item of furniture according to claim 12, further comprising at least one pole being a scratching post and supporting said bed.

14. The item of furniture according to claim 13, wherein said at least on pole is two poles each have brackets for supporting said bed.

15. The item of furniture according to claim 14, further comprising a hammock suspended from said brackets.

16. The item of furniture according to claim 1, further comprising a supply holder disposed in said sanitary compartment.

17. The item of furniture according to claim 1, further comprising two hooks disposed in said sanitary compartment for holding a litter disposal bag.

18. The item of furniture according to claim 1, further comprising at least one door for closing said sanitary compartment, said at least one door having at least one pet entrance opening formed therein.

19. The item of furniture according to claim 18, wherein said at least one door is two doors each having a complementary one of said openings formed therein.

20. The item of furniture according to claim 1, further comprising a roll top door for closing said feeding compartment.

21. A pet furniture item, comprising:
a sanitary compartment for receiving a litter box therein;
a feeding compartment being separate from said sanitary compartment;
a litter container having a slanted bottom region, said litter container storing clean unused litter to be dispensed into the litter box; and
a litter dispenser attached to said litter container at said slanted bottom region.

22. The item of furniture according to claim 21, wherein said litter dispenser is a hose.

23. A pet furniture item, comprising:
a sanitary compartment for receiving a litter box therein;
a litter container having a slanted bottom region, said litter container storing clean unused litter to be dispensed into the litter box; and
a litter dispenser being a hose attached to said litter container at said slanted bottom region.

24. (canceled)
